(19) United States
(12) Patent Application Publication
(10) Pub. No.: US 2010/0086723 A1
(43) Pub. Date: Apr. 8, 2010

(54) STONE-GLASS ELEMENT WITH CAPILLARY CUT

(76) Inventors: Johannes Blanke-Bohne, Bochum (DE); Reinhold Marquardt, Gelsenkirchen (DE)

Correspondence Address: Walter A Hackler;Patent Law Office, 2372 S.E. Bristol Street Suite B, Newport Beach, CA, 92660-0755, US

(21) Appl. No.: 12/309,981

(22) PCT Filed: Jul. 21, 2007
(86) PCT No.: PCT/DE2007/001307

§ 371 Date: Jul. 14, 2009

(30) Foreign Application Priority Data
Aug. 7, 2006 (DE) 20 2006 012 039.4

(51) Int. Cl. E04F 13/14; E04B 2/28; B32B 9/04; B32B 17/06; E04B 2/88; E04C 2/24

(52) U.S. Cl. 428/60; 428/188; 428/120; 428/61; 428/67; 52/235; 52/309.1

(57) ABSTRACT

A stone-glass element having at least one stone plate (2) and a supporting plate (1), comprising at least one glass pane which is bonded “large area” to said stone plate by means of a transparent or opaque cast resin layer (4), with the surface of the stone plate opposite of the supporting plate being provided with a moisture-repellant cover layer (7) or a cover plate (3), is characterized in that the stone plate comprises a capillary cut (15) in parallel to at least one side edge being filled with a sealing compound which prevents a moisture diffusion (6) towards the stone plate's (2) interior. It is thus possible to prevent by simple means moisture from diffusing into the stone's interior in case of a stone-glass element of the above-mentioned type to preclude heavy consequential damage from happening. In the process a visual or esthetical impairment, respectively, of the element is to be minimal, if possible, and the technical expense is to preclude considerable cost increases. Construction of frameless façades shall be feasible as before.

The invention concerns a stone-glass element having at least one stone plate and a supporting plate, comprising at least one glass pane which is bonded “large area” to said stone plate by means of a transparent or opaque cast resin layer, with the surface of the stone plate opposite of the supporting plate being provided with a moisture-repellant cover layer and/or a cover plate.

A stone-glass element of this kind is known from EP 0 799 949 B1. This patent, too, specifically proposes a stone-glass element having a symmetrical composition glass/stone/glass. Ever since 1996 such elements have been fabricated, in particular using natural stone plates and have been used both in a cold and in a warm environment. In the latter case various stone plate elements as well may have been used in the composition of the stone plate.

Here a special feature is that the large size natural stone plates are almost completely sealed. The elements' cutting edges, however, usually are open and accessible to moistures, whereby the capillary action of the natural stones and their water absorption capability may cause a change in appearance (darkening). Due to its unprotected edges such a glass-stone composite may not be exposed to the open atmosphere. Whenever a natural stone is further embellished by an artist's work (high value paintings or graphics) the desire to locate this element in the open air is second to none. In this case as well measures designed to protect the element, and the lateral edges in particular, are necessary.

A completely tight sealing around all edges cannot be recommended without limitations being made as well, however, because in case of a tense incident solar radiation and high temperatures a back pressure caused in the interior of the composite could not be compensated for otherwise. For this purpose, compensation options must be provided.

The cast resins proposed in EP 0 799 949 B1 are capable of regulating a minimum moisture absorption without consequential damage being caused to the composite in combination only with the bonding agents indicated there, which are required to be admixed in coordination with the variety of the stone used. If an arbitrary commercially available cast resin, such as a glass/glass composite, is used, however, and even combined with an extremely hydrophilic natural stone, such as alabaster, a stone-glass composite is highly jeopardized. A sumptuous façade, which presently is still in place, made for the Chemnitz State Central Bank (LZB) by Flabeg Steinglas GmbH, Recklinghausen, today operated under the name of NGV GmbH, Recklinghausen, has to be exchanged in toto due to significant delamination and changes in the appearance which intervened still prior to the acceptance. Both the composite structure was destroyed and the stone decayed owing to the influence of moisture.

Problems are to be expected whenever the stone is bonded or sealed, respectively, on both sides with water-tight materials (plates made of glass, stone and metal, and varnishes, etc.). Thereby the stone plate which is thin in most cases, having a thickness of less than 1 cm, develops a considerable capillary action. Once water has risen—well up to a height of 30 cm—said water will get out of the stone only very slowly again via the open tiny cutting surfaces which have remained.

Thus the object of the invention is to prevent by simple means moisture from diffusing into the stone's interior in case of a stone-glass element of the type mentioned in the introduction to preclude such heavy consequential damage from happening. In the process a visual or esthetical impairment, respectively, of the element is to be minimal, if possible, and the technical expense is to preclude considerable cost increases. Construction of frameless façades shall be feasible as before.

### SUMMARY OF THE INVENTION

This object will be solved according to the invention in a surprisingly simple however very effective way in that the stone plate comprises a capillary cut in parallel to at least one side edge being filled with a sealing compound which prevents moisture from diffusing towards the stone plate's interior.

After the bonding of the supporting plate and the stone plate the capillaries will be severed by making a cut in a short distance from the edge, if possible. Transparent or translucent sealing compounds, respectively, and sealing compounds which are compatible with natural stones are commercially available. The chemical and visual compatibility with the cast resin and also with the stone used is a prerequisite.

In the standard case the capillary cut is made in a perpendicular configuration to the surface of the stone plate. This operation may be done by making a simple saw cut.

Whenever the element is to be frame-mounted this type of insulation may be sufficient to preclude diffusion action. The capillary cut which might be visible as well having the width of a saw blade may be “hidden” in the mounting frame.

To keep the visible capillary cut as thin as possible saw blades as thin as possible having a very small diameter may be used initially. More elaborate options are available when eroding processes are used.

It is further proposed to make the capillary cut in a transversal configuration to the stone plate's surface in order to keep the visible dividing line as thin as possible.

Advantageously, the stone material remains visible when a transparent adhesive agent is used.

The stone plate is severed completely whenever a diffusion is to be fully avoided. The disadvantage in such cases is that a visible dividing line is brought into being.

Whenever a diffusion barrier profile, e.g. of metal, will be used, this profile may be mounted with a very narrow butt joint forward of the first composite at the edge of the natural stone using a sealing compound. Then the profile may also form the finished edge of the element after completion of the composite flush with the supporting and cover plate.

If there is a requirement that the pressure be compensated by the stone slab, porous materials or hollow profiles unilaterally open towards the side of the stone as well may be mounted directly at the edge of the stone plates, with the capillary cut joining thereto.

If a dividing line is not intended to come into being as usually is the case with capillary cuts, an alternative proposition in such cases is that on at least one of the two opposite surfaces of the stone plate a capillary cut incompletely severing the stone plate having the shape of a profiled groove is provided. In doing so, the rest of the stony material left behind on the bottom of each profiled groove forming a web (1 mm to 3 mm) may be provided with moisture-repelling properties due to impregnation or chemical treatment. Owing to this, the stone remains visible, the web, however, is no longer capable of enabling diffusion. The maximally permissible exact thickness of the web may only be determined in individual tests with the relevant type of stone.

The simplest capillary cut is made using a saw and thus has a rectangular cross section. The visible width of the cut is disadvantageous. If off-set cuts are made, however, from both stone surfaces in parallel to the edge a thin dividing line may be generated. The depth of both cuts may produce both a web as well as a larger separation cross section. In all events the offset is advantageous from the visual point of view.

By using a milling operation the capillary cut may be made in a V-shaped configuration. If the latter is made from both stone surfaces, a thin dividing line may be generated. Here as well a stone web may be brought into being, though.

An almost equally similar result is achieved in capillary cuts by using round milling heads. In most cases the capillary cuts are to begin at a distance as small as possible off the relevant side edge of the stone plate. If the cover plate is applied using the cast resin method a distance and a sealing band still has to be fitted onto the remaining edge for pouring in the liquid cast resin thereafter.

The unavoidable stone strip caused by this operation is still exposed to diffusion. The absorption of water, however, is a very limited one here, and the area of diffusion for the dissipation of the water relative to the amount of water is very large.

The absorption of water may be further reduced and simultaneously the open dissipation surface enlarged if a cut extending in parallel to both surfaces of the stone plate opposing each other is made on the outwardly pointing side surface of the stone plate which adjoins to a side edge to which the capillary edge extends in parallel. This being the case, the stone is preserved at the exposed surfaces showing the same behaviour in this region, however, as is the case with the non-jeopardized stone-glass elements having adhesives on one side only.

In those cases where pre-stressed glass is not used it lends itself to have the capillary cuts made with an element allowance terminated by edging the stone-glass element with a side edge of the final element measurement. Thereby any visual impairment may be precluded.

As a rule the stone-glass elements concerned include a cover which is bonded with the stone plate by means of a cast resin layer. Preferably, this cast resin layer comprises the same components and properties as the layer which is used between the support plate and the stone plate.

Whereas the cover plate is predominantly made of glass, the cover plate may well be made from a different material. It occurs very frequently, however, that due to the desired translucency another glass plate is preferred as a cover plate. It is just because of the translucency that the capillary cuts (made transversally) which are hidden by stony material are proposed in this case since the visual impairment caused is least. In the case of cuts being made from both surfaces of the stone plates, a combination of transversal and perpendicular cuts may be made as well to prevent a visible dividing line in the capillary cut.

If translucency is not desired, however—e.g. because the stone is not suited for this—metal plates may be considered as coverings, which may have a textured shape as well. Wooden boards, and derivatives thereof are conceivable as a covering, too.

In a variant of the invention a further stone plate serving as a covering exhibits certain advantages. The weather-resistant glass side could be inverted to the outside, whereas the natural surface of the second stone plate would be preferred for the interior. Relevant examples include granite, marble, alabaster, slate, cast stone. In the simplest case the covering may have been implemented of a moisture-repellant varnish or a plastic layer only on the surface of the stone plate facing the support plate. Predominantly, this is a transparent material providing a certain protection against soiling, e.g. caused by coloured liquids such as red wine, etc.

Advantageously this may also be a thin layer as proposed in PCT WO 2006/079310 A1 as a diffusion barrier in order to prevent matters from migrating into the material or out of the material. This includes moist and liquid matters as well, among others also water. The potential and optimizing components of such a layer have been described therein fairly extensively.

Any potential cover plates may well have been provided unilaterally with a thin cover layer yet, in particular those having hygroscopic capability. The capillary cut may then be extended to include the cover plate.

A particularly sought-after spatial structural element may be produced if, initially, the composite element has a cover layer on the side of the stone plate only. A V-shaped groove may be unilaterally extended up to the cover layer in this application. Upon filling of the sealing compound one of the two parts, which are merely joined by the cover layer, may be turned upward, thus creating angular structural elements with ingress of moisture into the flute being prevented by the capillary cut which is present there. In this application an arbitrary distance to the edge may be assumed. Various spatial shapes may be created by repeatedly applying this specific capillary cut which are always protected in an ideal fashion against moisture absorption.

Due to the presence of a continuous layer the static characteristics of these elements are good. Numerous parameters may be used to set the static characteristics of this layer, such as geometric layer thickness, harshness, tensile strength, and the basic material used.

The cover layer may well represent the finished surface of the end product yet or may be subject to smoothing or polishing processes, respectively, with the reflective characteristics being determined thereby. The layer thickness will vary between 0.05 to 2 mm and is based on materials such as epoxides, acrylates, polyurethanes, silicons or unsaturated polyester resins. These may be polymerized thermically and/or optically.

Absolutely indispensable additives make sure that the elements will remain durably bonded and will exhibit a long-lived optical stability as well. Thus primers, UV absorbers, and anti-oxidantia will be admixed as required.

The same applies to the cast resins producing the composite, support and cover plates/stone and, in further applications, cover plate/cover layer.

If a further cover plate is mounted the cover layer is of a minor thickness and is 1 μM to 500 μm according to the application.

A cover layer particularly serves as a positively defined subbase for yet another embellishment of the element, which in most cases is designed to provide an aesthetic supplement of the stone structures. Paintings, graphical works of art, reliefs or ornamental inlays as well (fabrics, metal grating, rods, etc.) may be provided here. Cast resin pigmentation covering large areas and mixtures are also possible.

In such cases glass is preferred as a cover plate.

If the capillary cut is filled with the same cast resin as is used for the bonded “large area” the capillary cut may be provided which saves efforts and costs. This could be achieved in a single process. In case of optically polymerizing cast resins a bilateral cut would always be preferred since the cast resin depth in the capillary cut may be maintained at a sufficiently low level.

If a cover layer is applied it lends to itself to fill the capillary cuts with the same cast resin as was used for the cover layer. Here the advantage is that the capillary cut is not yet covered by a plate and that the bubble-free filling of the capillary cut may be still safeguarded and aided manually, which in particular, may be necessary in thinly made capillary cuts.

If, however, the capillary layer is too deep for a visually-controlled polymerisation, diverse sealing compounds have to be used in a separate process for the cast resin, which, on the one hand must be chemically compatible with the cast resin and the stone plate and on the other hand have to have similar optical characteristics like the cast resin.

Further measures serve the purpose of increasing the diffusion barrier's reliability even more in the case of extreme humidity conditions. Thus materials forming a moisture barrier such as glass, metal, plastic gaskets or strips, or profiled or hose-shaped sealings, respectively, may be inserted or bonded, respectively. In any case this is an elaborate separate process, however.

Another variant to increase the reliability of the diffusion barrier is to make plural capillary cuts extending in parallel. The disadvantage is that the visual impairment which is a minor one though, occurs several times.

Further capillary cuts on further element edges are possible. In case of edges extending horizontally a tight moisture barrier should always be installed. It is just at the lower side of the element that a large number of hanging drops forms rising in the capillaries and causing at least a visual darkening of the stone.

The capillary cut may well be worthwhile also in a lateral configuration (vertical mounting direction), even without sealing compounds being filled in, i.e. as a hollow space because only then only a highly reduced capillary action is present and the moisture caused as a rule is quickly running off laterally. This enables the pressure of the composite element to be compensated into the ambience. In addition, the lateral web may be impregnated to be moisture-repellant.

Whenever all edges of an element are to be provided with filled and tight capillary cuts it is proposed to insert an additional functional profile into the capillary cut, which is porous or fully open towards the stone edge. A hollow profile may also be used. A pressure compensation may then be taken for granted by using unsophisticated functional elements, such as gauges, hollow needles, etc.

However, such an arrangement as well may be used for accommodating miniature measuring devices, e.g., for pressure, temperature, and moisture, etc.

A negative pressure, e.g., may be applied to the cutting edges of the natural stone via simple gauges. In doing so, the tightness of the capillary cut may be tested on the one hand, and on the other hand it may be beneficial to apply a permanent negative pressure to evacuate in part the capillaries of the stone plate.

Sealing material, barriers applied, functional profiles, and functional elements may be realized in an arbitrary number of combinations. Further advantages of the invention may be extracted from the description and the drawings. Moreover, the features mentioned above and in addition may be used in accordance with the invention either individually or collectively in an arbitrary number of combinations. The embodiments shown and desired are not to be understood as an exhaustive enumeration but rather have an exemplary character for the description of the invention.

### BRIEF DESCRIPTION OF THE DRAWINGS

Seen in an exploded sectional view each:

FIG. 1 shows a complete perpendicular capillary cut severing the stone;

FIG. 2 shows a complete transversal capillary cut severing the stone;

FIG. 3 shows an incomplete capillary cut in which the visual surface is preserved;

FIG. 4 shows an incomplete capillary cut in which a central stone web comes into being;

FIG. 5 shows a complete bilaterally transversal capillary cut;

FIG. 6 shows a complete bilaterally vertical capillary cut;

FIG. 7 shows a complete bilaterally milled capillary cut having a V-shape;

FIG. 8 shows a complete bilaterally milled capillary cut, having a round shape;

FIG. 9 shows a complete perpendicular capillary cut, with a diffusion barrier profile being mounted;

FIG. 10 shows a complete perpendicular capillary cut, with hose-shaped sealings being mounted; and

FIG. 11 shows two complete perpendicular capillary cuts.

FIG. 12 shows a functional profile bonded with the stone plate.

FIG. 13 shows the preparation of a symmetrical V-shaped groove for the manufacture of an angular element having a capillary cut.

FIG. 14 shows a finished angular element without cover plate.

FIG. 15 shows a finished angular element with a cover plate, e.g. of glass.

### DETAILED DESCRIPTION

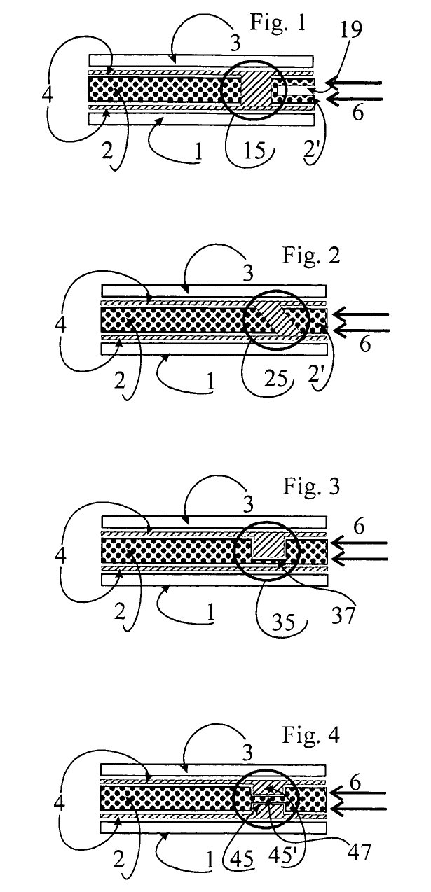

The sectional views of FIGS. 1 to 11 each in principle show the same composition of a stone-glass element, having at least one stone slab 2 and a supporting plate 1, comprising at least one glass pane which is bonded “large area” to said stone plate 2 by means of a transparent or opaque cast resin layer 4, with the surface of the stone plate 2 opposite of the supporting plate 1 being provided with a moisture-repellent cover 3 having the shape of a layer or of a further plate. The region highlighted by means of a circle or an ellipse, respectively, represents capillary cut 5 of FIGS. 1 to 11 which has a different configuration. The moisture diffusion 6 sets out at the exposed cutting surface of the stone.

FIG. 1 shows a complete perpendicular capillary cut 15 severing the stone. In horizontal cut 19, depicted horizontally herein, also constituting a representation of the remainder of FIGS. 2 to 11, it is shown how the absorption of water in the edge strip caused by capillary cut 15, is further reduced and simultaneously the open dissipation surface is enlarged, with the visual surface of the stone strip, however, being preserved.

FIG. 2 shows a complete transversal capillary cut 25 severing the stone. The potential optical overlapping of the stony material is advantageous, due to which the capillary cut is hardly conceivable.

FIG. 3 shows an incomplete capillary cut having a profiled groove, due to which a groove bottom 35 comes into existence. The visual surface of the stone towards the glass supporting plate 1 is preserved in this case by means of web 37 which is left behind.

FIG. 4 shows an incomplete capillary cut whereby a central stony web 47 having the two groove bottoms 45 and 45′ comes into existence.

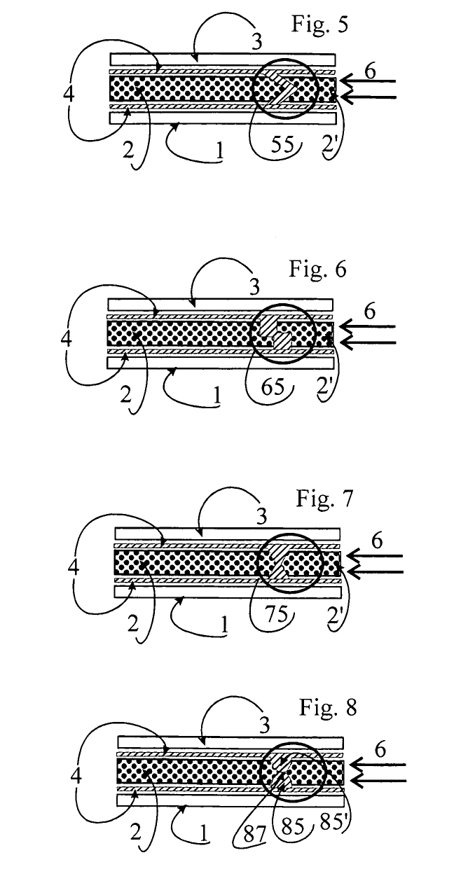

FIG. 5 shows an incomplete transversal capillary cut 55, which is made diametrically opposed in a transversal configuration and thus does not exhibit a visible dividing line from any perspective.

FIG. 6 shows a complete vertical capillary cut 65 which is made diametrically in an offset configuration and may thus maintain the visible dividing line at a minimum.

FIG. 7 shows a complete milled capillary cut 75 having a V-shape which is also made from the opposite side and may thus maintain the visible dividing line at a minimum.

FIG. 8 shows a completely milled capillary cut having a round shape which is also made diametrically wherein two groove bottoms 85, 85′ are coming into existence and a narrow web 87 is produced.

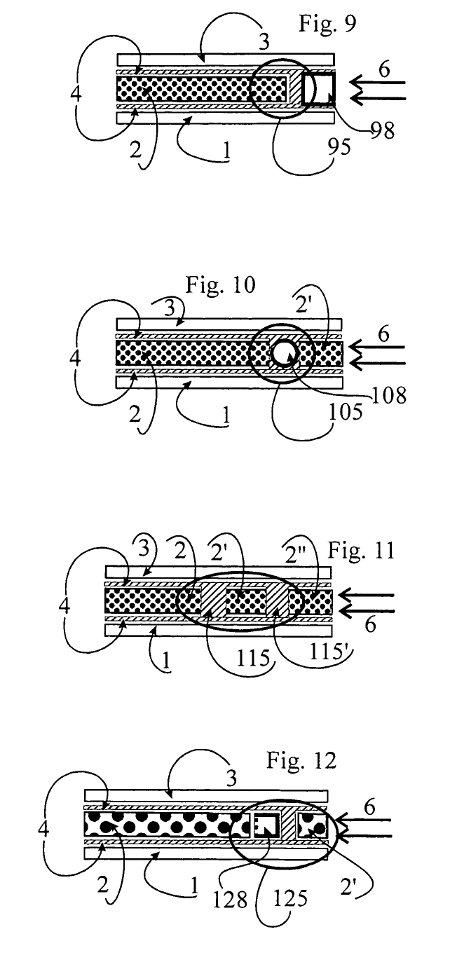

FIG. 9 shows a complete perpendicular capillary cut 95, with a diffusion barrier profile 98 being mounted, inhibiting the diffusion entirely and positively. As outlined here, the edge of the element may be formed by such a profile.

FIG. 10 shows a complete perpendicular capillary cut 105 with hose-shaped sealings 108 being mounted inhibiting diffusion.

FIG. 11 shows two complete perpendicular capillary cuts 115, 115′, which represent an additional safe diffusion barrier.

FIG. 12 shows a functional profile bonded with the stone plate 128.

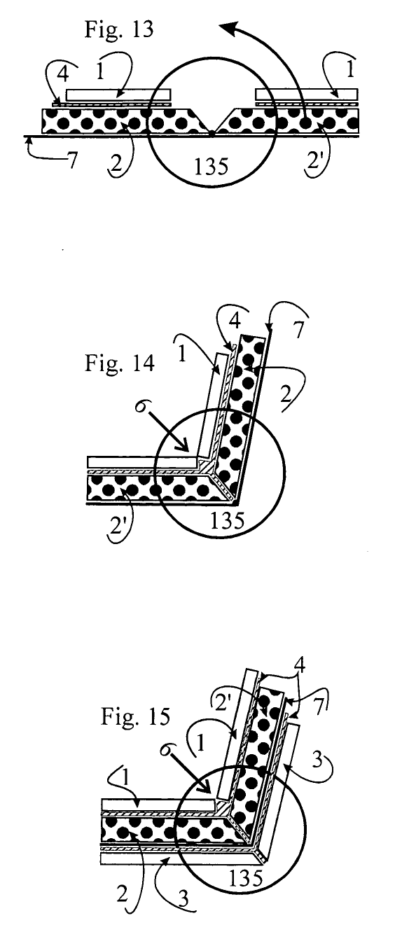

FIG. 13 shows a specific V-shaped groove 205, extending up to the cover layer 7, which, however, does not separate said layer. In the process an angular structural element is produced by turning upward one of the parts 2 or 2′ which are only joined by the cover layer yet.

FIG. 14 shows a finished angular element, with the cover layer 7 equally being the finished surface of the final product.

FIG. 15 finally shows a completed angular structural element, with the cover layer 7 being bonded with a further cover plate 3—a glass pane in this case—by means of cast resin 4.

What is claimed is:

1. A stone-glass element having at least one stone plate (2) and a supporting plate (1), comprising at least one glass pane which is bonded “large area” to said stone plate (2) by means of a transparent or opaque cast resin layer (4), with the surface of the stone plate (2) opposite of the supporting plate (1) being provided with a moisture-repellant cover layer (7) and/or a cover plate (3),
characterized in that
the stone plate (2) comprises a capillary cut (15; 25; 35; 45, 45′; 55; 65; 75; 85, 85′; 95; 105; 115, 115′, 125, 135) in parallel to at least one side edge being filled with a sealing compound which prevents a moisture diffusion (6) towards the stone plate's (2) interior.

2. The stone-glass element according to claim 1, characterized in that the stone plate (2) is composed of various stone plate elements.

3. The stone-glass element according to claim 1, characterized in that the capillary cut (15; 35; 45, 45′; 65; 95; 105; 115, 115′, 125, 135) is made in a perpendicular or in a transversal configuration to the surface of the stone plate (2).

4. The stone-glass element according to claim 1, characterized in that the stone plate is completely severed into two plate sections (2, 2′) by the capillary cut (15, 25, 55, 65, 75, 95, 105, 115, 115′, 125, 135).

5. The stone-glass element according to claim 4, characterized in that between the two plate sections (2, 2′) a porous or open material or functional profile (128) is provided abutting the edge of the stone plate (2) at least towards the stone plate (2) which is joined by the capillary cut (125).

6. The stone-glass element according to claim 1, characterized in that the capillary cut (15, 25, 55, 65, 75, 95, 105, 115, 115′, 125, 135) is used as a butt joint between the stone plate (2) and a moisture barrier material (98, 108, 128).

7. The stone-glass element according to claim 1, characterized in that the capillary cut terminates by edging the stone-glass element with a side edge of the element.

8. The stone-glass element according to claim 1, characterized in that the cover layer (7) is composed based on epoxy resins, acrylates, polyurethanes, silicones or unsaturated polyester resins.

9. The stone-glass element according to claim 8, characterized in that the cover layer (7) is embellished by paintings or graphic art which have been applied separately, pigmentation of specific areas and/or mixtures thereof by adding colours and/or surface structures and/or ornamental inlays.

10. The stone-glass element according to claim 1, characterized in that both a cover plate (3) and a cover layer (7) on the basis of epoxy resins, acrylates, polyurethanes, silicons or unsaturated polyester resins are present.

11. The stone-glass element according to claim 8, characterized in that in the cover layer (7) and/or in the cast resin layer (4) primers on the basis of one or plural silanes and/or titanates and/or aluminates are present homogeneously distributed.

12. The stone-glass element according to claim 8, characterized in that in the cover layer (7) and/or in the cast resin layer (4) further substances are present homogeneously distributed absorbing the radiation in the wavelength range of ultraviolet (UV) light.

13. The stone-glass element according to claim 8, characterized in that in the cover layer (7) and/or in the cast resin layer (4) further substances are present homogeneously distributed deactivating the radical structures caused by chemical oxidation.

14. The stone-glass element according to claim 1, characterized in that in the capillary cut (95; 105) materials forming a moisture barrier such as glass, metal, plastic (98) gaskets or strips, or profiled or hose-shaped sealings (108) are inserted or adhesively bonded, respectively.

15. The stone-glass element according to claim 1, characterized in that the capillary cut (135) is made in a unilaterally V-shaped configuration, and that the plate sections (2, 2′) only bonded yet by the covering layer (7) are aligned in an angular configuration to each other and thus form a spatial shape.
